(19) United States
(12) Patent Application Publication
(10) Pub. No.: US 2025/0005931 A1
(43) Pub. Date: Jan. 2, 2025

(54) METHOD FOR PROCESSING INFORMATION, INFORMATION PROCESSING SYSTEM AND STORAGE MEDIUM

(71) Applicant: YAMAHA CORPORATION, Hamamatsu-shi (JP)

(72) Inventors: Akira MAEZAWA, Hamamatsu-shi (JP); Takahisa INOUE, Hamamatsu-shi (JP); Takashi YAMASHIRO, Hamamatsu-shi (JP); Daiki YOSHIOKA, Tokyo (JP); Shotaro WATANABE, Hamamatsu-shi (JP); Shingo EKUNI, Hamamatsu-shi (JP)

(21) Appl. No.: 18/885,958

(22) Filed: Sep. 16, 2024

Related U.S. Application Data
(63) Continuation of application No. PCT/JP2022/048174, filed on Dec. 27, 2022.

(30) Foreign Application Priority Data
Mar. 25, 2022 (JP) 2022-049259

(51) Int. Cl. G06V 20/52; G02B 27/01; G06F 3/01; G06F 3/16; G10D 3/00

(52) U.S. Cl. CPC G06V 20/52; G02B 27/0172; G06F 3/012; G06F 3/16; G10D 3/00

(57) ABSTRACT

An information processing system includes an information acquirer configured to acquire input information including finger information relating to a finger of a user playing a string instrument and an image of a fretboard of the string instrument and sound information of sound of the string instrument played by the user, and an information generator configured to generate fingering information indicative of fingering by processing the acquired input information using a generation model that learns a relationship between training input information and training fingering information.

### CROSS REFERENCE TO RELATED APPLICATIONS

This Application is a Continuation Application of PCT Application No. PCT/JP2022/048174 filed on Dec. 27, 2022, and is based on and claims priority from Japanese Patent Application No. 2022-049259 filed on Mar. 25, 2022, the entire contents of each of which are incorporated herein by reference.

### BACKGROUND

### Field of the Invention

This disclosure relates to a technique for analyzing playing of a string instrument.

Various techniques have been proposed for assisting users in playing string instruments. For example, Japanese Patent Application, Laid-Open Publication No. 2005-241877, discloses a technique for showing on a display, an image representative of fingering of a chord on a string instrument.

### SUMMARY

When playing a string instrument, different fingerings can be used to produce a same pitch on the same instrument. When practicing a string instrument, a user may wish to check their fingering against a model fingering or against a fingering of a particular player, for example. Moreover, the user may wish to check their fingering when playing the string instrument. In view of these circumstances, one aspect of this disclosure is to provide fingering information to the user who plays the string instrument.

To achieve the above-stated object, a method according to an aspect of this disclosure is a computer-implemented method for processing information that is executable by a computer system. The method includes: acquiring, by the computer system, input information including: finger information relating to fingers of a user playing a string instrument and an image of a fretboard of the string instrument; and sound information of sound of the string instrument played by the user; and generating, by the computer system, fingering information indicative of fingering by processing the acquired input information using at least one generation model that learns a relationship between training input information and training fingering information.

An information processing system according to an aspect of this disclosure includes: at least one memory storing a program; at least one processor configured to execute the program to: acquire input information including: finger information relating to fingers of a user playing a string instrument and an image of a fretboard of the string instrument; and sound information of sound of the string instrument played by the user; and generate fingering information indicative of fingering by processing the acquired input information using at least one generation model that learns a relationship between training input information and training fingering information.

A computer-readable non-transitory storage medium according to an aspect of this disclosure is a recording medium for storing a program executable by a computer system to execute a method of: acquiring input information including: finger information relating to a finger of a user playing a string instrument and an image of a fretboard of the string instrument; and sound information of sound of the string instrument played by the user; and generating fingering information indicative of fingering by processing the acquired input information using at least one generation model that learns a relationship between training input information and training fingering information.

### BRIEF DESCRIPTION OF THE DRAWINGS

FIG. 1 is a block diagram showing an example of a configuration of an information processing system.

FIG. 2 is a schematic diagram of an image showing playing.

FIG. 3 is a block diagram showing an example of a functional configuration of the information processing system.

FIG. 4 is a flow chart showing image analysis procedures.

FIG. 5 is a schematic diagram of a reference image.

FIG. 6 is a flow chart showing playing analysis procedures.

FIG. 7 is a block diagram showing an example of a configuration of a machine learning system.

FIG. 8 is a block diagram showing an example of a functional configuration of the machine learning system.

FIG. 9 is a flow chart showing machine learning procedures.

FIG. 10 is a block diagram showing an example of a functional configuration of an information processing system according to a third embodiment.

FIG. 11 is a block diagram showing an example of a functional configuration of an information processing system according to a fourth embodiment.

FIG. 12 is a block diagram showing an example of a functional configuration of a machine learning system according to the fourth embodiment.

FIG. 13 is a schematic diagram of a reference image according to a modification.

FIG. 14 is a block diagram showing an example of a functional configuration of an information processing system according to a modification.

FIG. 15 is a block diagram showing an example of a functional configuration of an information processing system according to a modification.

### MODES FOR CARRYING OUT THE INVENTION

### A: First Embodiment

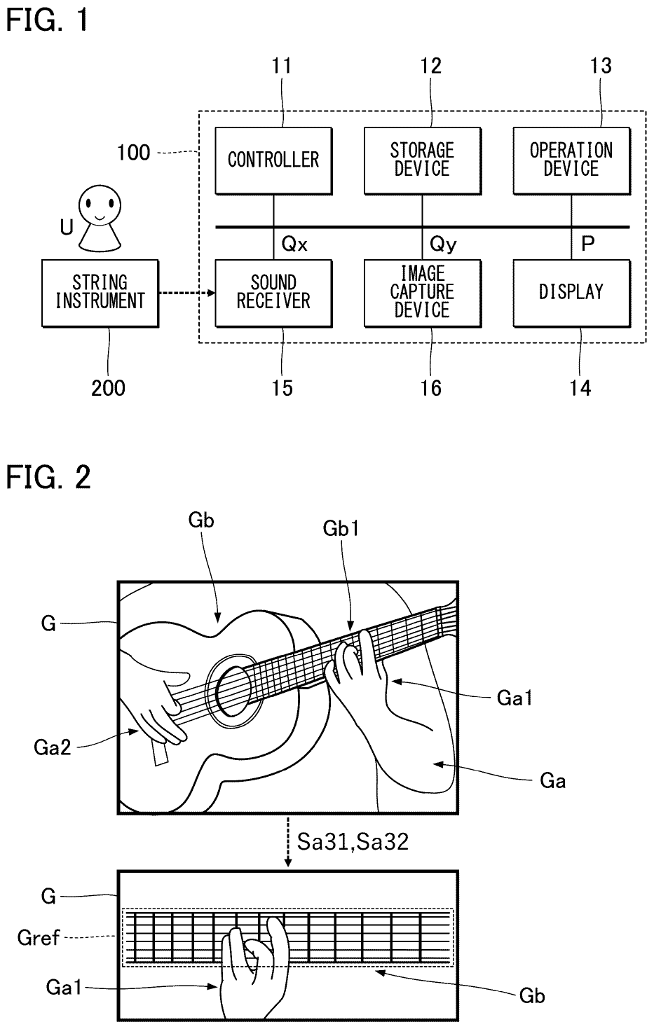

FIG. 1 is a block diagram showing an example of a configuration of an information processing system 100 according to a first embodiment. The information processing system 100 is a computer system (playing analysis system) that analyzes playing of a string instrument 200 by a user U. The string instrument 200 is, for example, a natural instrument, such as an acoustic guitar that has a fretboard and strings. The information processing system 100 according to the first embodiment analyzes fingering of the user U when playing the string instrument 200. The term “fingering” refers to how the user U uses his/her fingers when playing the string instrument 200. Specifically, a combination of fingers that the user U uses to fret strings on the fretboard and positions on the fretboard at which the user frets the strings are analyzed to obtain fingering of the user U when the user U plays the string instrument 200.

The information processing system 100 includes a controller 11, a storage device 12, an operation device 13, a display 14, a sound receiver 15, and an image capture device 16. The information processing system 100 is a portable information device such as a smartphone or a tablet. Alternatively, the information processing system 100 is a portable or desktop information device, such as a personal computer. The information processing system 100 may be implemented by a single device or by more than one device.

The controller 11 comprises one or more processors for controlling operation of the information processing system 100. Specifically, the controller 11 comprises one or more processors, such as CPUs (Central Processing Units), GPUs (Graphics Processing Units), SPUs (Sound Processing Units), DSPs (Digital Signal Processors), FPGAs (Field Programmable Gate Arrays), or ASICs (Application Specific Integrated Circuits).

The storage device 12 comprises one or more memories for storing programs executed by the controller 11 and a variety of types of data used by the controller 11. The storage device 12 may be a known recording medium, such as a semiconductor recording medium or a magnetic recording medium, or a combination of different types of recording media. For example, the storage device 12 may be a portable recording medium that is attached to or detached from the information processing system 100, or a recording medium (e.g., a cloud storage) that is accessed by the controller 11 via a network.

The operation device 13 is an input device that receives input operations made by the user U. For example, the operation device 13 may be an input operator used by the user U, or a touch panel for detecting touch inputs of the user U. The display 14 shows a variety of images under control of the controller 11. The display 14 may be one of a variety of display panels, such as a liquid crystal display panel or an organic EL panel. The operation device 13 or the display 14 separate from the information processing system 100 may be connected to the information processing system 100 by wire or wirelessly.

The sound receiver 15 is a microphone that receives music sound produced by the string instrument 200 when played by the user U to generate an audio signal Qx. The audio signal Qx indicates a wave form of the music sound generated by the string instrument 200. The sound receiver 15 is separate from the information processing system 100 and may be connected to the information processing system 100 either by wire or wirelessly. Illustration of an A/D converter for converting the audio signal Qx from analogue to digital format is omitted for convenience.

The image capture device 16 captures images of the user U when playing the string instrument 200, to generate an image signal Qy. The image signal Qy is a video signal representative of the user U playing the string instrument 200. Specifically, the image capture device 16 includes an optical system (e.g., lens), an image sensor that receives incident light from the optical system, and processing circuitry for generating an image signal Qy based on an amount of light received by the image sensor. The image capture device 16 is separate from the information processing system 100 and may be connected to the information processing system 100 either by wire or wirelessly.

FIG. 2 is an explanatory diagram of an image captured by the image capture device 16. An image G represented by the image signal Qy (hereinafter, “playing image”) includes a player image Ga and an instrument image Gb. The player image Ga represents the user U who is playing the string instrument 200. The instrument image Gb represents the string instrument 200 that is being played by the user U. The player image Ga includes an image Ga1 representative of the left hand of the user U (hereinafter, “left hand image”) and an image Ga2 representative of the right hand of the user U (hereinafter, “right hand image”). In the following description, it is envisaged that the left hand of the user U is used to fret strings and the right hand is used to pluck strings. However, the left hand of the user U may be used to pluck strings and the right hand may be used to fret strings. The instrument image Gb includes an image Gb1 representative of the fretboard of the string instrument (hereinafter, “fretboard image”).

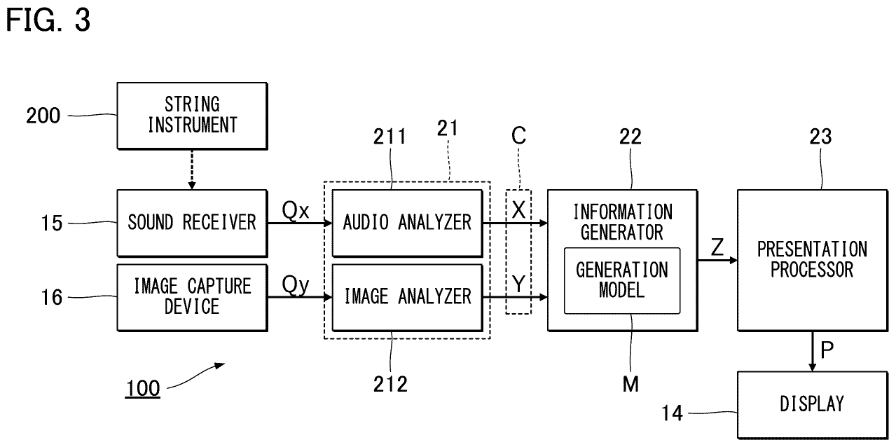

FIG. 3 is a block diagram showing an example of a functional configuration of the information processing system 100. The controller 11 executes a program stored in the storage device 12 to implement functions for analyzing playing of the string instrument 200 by the user U (an information acquirer 21, an information generator 22, and a presentation processor 23).

The information acquirer 21 acquires input information C. The input information C is control data including sound information X and finger information Y. The sound information X is data on music sound of the string instrument 200 played by the user U. The finger information Y is data on a playing image G representing the user U playing the string instrument 200. Generation of the input information C by the information acquirer 21 is repeated sequentially in conjunction with playing of the string instrument 200 by the user U. The information acquirer 21 according to the first embodiment includes an audio analyzer 211 and an image analyzer 212.

The audio analyzer 211 analyzes an audio signal Qx to generate sound information X. By the sound information X according to the first embodiment, a pitch of a sound of the string instrument 200 played by the user U is identified. Thus, the audio analyzer 211 estimates a pitch of sound indicated by the audio signal Qx and generates sound information X for identifying the pitch. A known freely selected analysis technique may be employed to estimate a pitch indicated by the audio signal Qx.

The audio analyzer 211 sequentially detects an onset by analyzing the audio signal Qx. The onset is a time point at which a sound is produced by the string instrument 200. Specifically, the audio analyzer 211 sequentially analyzes a volume of the audio signal Qx within a predetermined cycle and detects an onset, which is a time point at which a volume exceeds a predetermined threshold. Given that a sound of the string instrument 200 is generated by plucking a string by the user U, an onset is a time point at which a string of the string instrument 200 is plucked by the user U.

The audio analyzer 211 generates sound information X upon detection of an onset. The sound information X is generated for each onset of the string instrument 200. Specifically, the audio analyzer 211 analyzes a sample of the audio signal Qx after elapse of a predetermined time (e.g., 150 milliseconds) from each onset, to generate sound information X. The sound information X at each onset represents a pitch of the music sound at the onset.

The image analyzer 212 generates finger information Y by analyzing the image signal Qy. The finger information Y according to the first embodiment represents a left hand image Ga1 of user U and a fretboard image Gb1 of the string instrument 200. The image analyzer 212 generates the finger information Y upon detection of an onset by the audio analyzer 211. The finger information Y is generated for each onset of the string instrument 200. For example, the image analyzer 212 analyzes the playing image G included in the image signal Qy after elapse of at a predetermined time (e.g., 150 milliseconds) from each onset, to generate finger information Y. The finger information Y at each onset represents the left hand image Ga1 and the fretboard image Gb1.

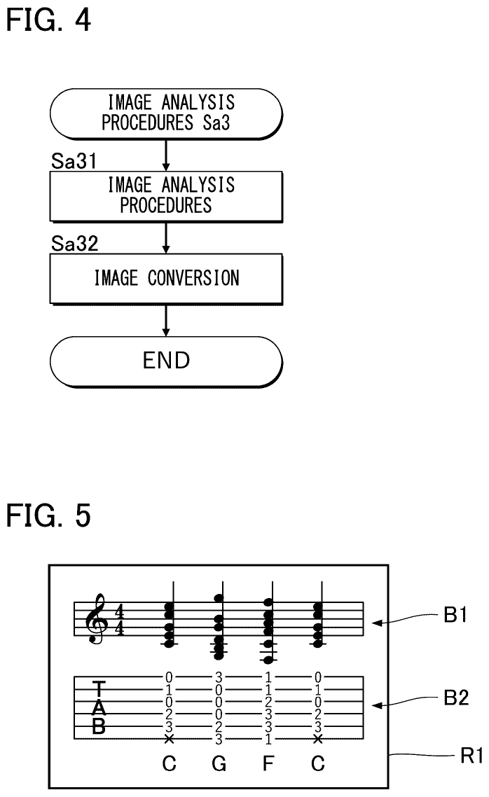

FIG. 4 is a flow chart showing procedures Sa3 by which finger information Y is generated by the image analyzer 212 (hereinafter, “image analysis procedures”). The image analysis procedures Sa3 start upon detection of an onset. Upon start of the image analysis procedures Sa3, the image analyzer 212 executes image detection (Sa31). The image detection is processing for extracting a left hand image Ga1 of the user U and a fretboard image Gb1 of the string instrument 200, from the playing image G represented by the image signal Qy. For example, the image detection is implemented by object detection using a statistical model, such as a deep neural network.

The image analyzer 212 executes the image conversion (Sa32). The image conversion is image processing for conversion of a playing image G, by which as shown in FIG. 2, a fretboard image Gb1 is converted into an image representative of the fretboard viewed from a predetermined orientation and distance. For example, the image analyzer 212 converts the playing image G so that the fretboard image Gb1 fits within a rectangular reference image Gref along a predetermined direction. The conversion of the left hand image Ga1 of the user U but also that of the fretboard image Gb1 are executed. The image conversion may be implemented by any known image processing, such as projection conversion by which a conversion matrix generated from the fretboard image Gb1 and the reference image Gref is applied to the playing image G. The image analyzer 212 generates finger information Y representative of the playing image G to which the image conversion has been applied.

As described above, the sound information X and the finger information Y are generated for each onset. Specifically, the information acquirer 21 generates input information C for each onset of the string instrument 200. A time series of pieces of input information C corresponding to a plurality of different onsets is generated.

The Information generator 22 shown in FIG. 3 generates fingering information Z from input information C. The Fingering information Z is any type of data representative of fingering during playing of the string instrument 200. Specifically, by the fingering information Z, at least one finger used to fret a string of the string instrument 200 and a position at which the finger frets the finger are identified. For example, a fretted position is identified by a combination of a string of the string instrument 200 and a fret on the fretboard.

As described above, input information C is generated for each onset, and fingering information Z is generated by the information generator 22 for each onset. Thus, a time series of fingering information Z is generated for the plurality if different onsets. The generated fingering information Z for each onset represents a fingering at that onset. As will be clear from the foregoing description, in the first embodiment, acquisition of the input information C and generation of the fingering information Z are executed for each onset of the string instrument 200. As a result, generation of surplus fingering information when a string is pressed but not plucked by the user U can be avoided. It is of note that, acquisition of the input information C and generation of the fingering information Z may be repeated for differing predetermined cycles of onsets.

A generation model M is used by the information generator 22 to generate fingering information Z. Specifically, the information generator 22 causes the generation model M to process the input information C to generate the fingering information Z. The generation model M is a trained model that learns relationships between input information C and fingering information Z by use of machine learning. The generation model M outputs statistically reasonable fingering information Z for the input information C.

The generation model M is implemented by (i) a program executed by the controller 11 to perform an operation to generate the fingering information Z from the input information C, and (ii) variables applied to the operation (e.g. weighted values and biases). The program and the variables for the generation model M are stored in the storage device 12. The variables of the generation model M are preset by machine learning.

For example, the generation model M comprises a deep neural network. The generation model M may be any kind of deep neural network, for example, a Recurrent Neural Network (RNN) or a Convolutional Neural Network (CNN). The generation model M may be a combination of multiple types of deep neural networks. The generation model M may include an additional element, such as Long Short-Term Memory (LSTM) or Attention.

The presentation processor 23 presents fingering information Z to the user U. Specifically, the presentation processor 23 shows on the display 14, a reference image R1 as shown in FIG. 5. The reference image R1 includes musical scores B (B1 and B2) for use by the user U in playing the string instrument 200. The musical scores B1 is a staff showing notation corresponding to the fingering information Z. The musical score B2 is tablature showing fingering corresponding to the fingering information Z. The musical score B2 is an image containing six horizontal lines representative of the strings of the string instrument 200. In the musical score B2, numerals are shown, corresponding to strings to indicate in a time series frets at which strings should be fretted. The presentation processor 23 generates musical score information P using the time series of the fingering information Z. The musical score information P may be data in any format that represents the musical scores B shown in FIG. 5. The presentation processor 23 displays the musical scores B represented by the musical score information P on the display 14.

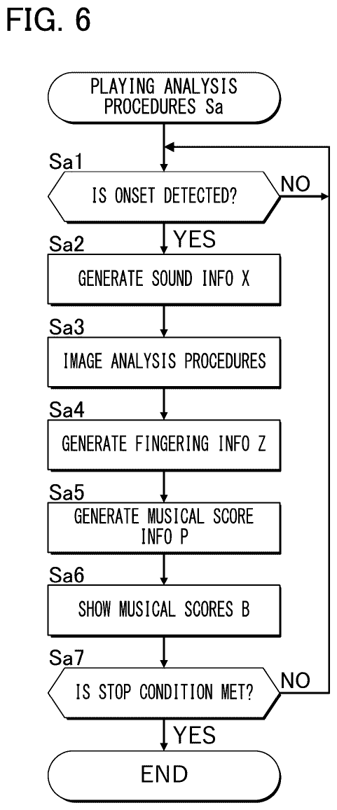

FIG. 6 is a flow chart showing procedures Sa that are executed by the controller 11 (hereinafter, “playing analysis procedures”). For example, the playing analysis procedures Sa start when the operation device 13 receives an instruction from the user U.

Upon start of playing analysis procedures Sa, the controller 11 (the audio analyzer 211) waits until an audio signal Qx is analyzed, and an onset is detected (Sa1: NO). If an onset is detected (Sa1: YES), the controller 11 (the audio analyzer 211) analyzes the audio signal Qx to generate sound information X (Sa2). Furthermore, the controller 11 (the image analyzer 212) executes the image analysis procedures Sa3 shown in FIG. 4 to generate finger information Y. The order of generations of the sound information X (Sa2) and the finger information Y (Sa3) may be reversed. Thus, input information C is generated for each onset of the string instrument 200. The input information C may be generated for a predetermined cycle.

The controller 11 (the information generator 22) causes the generation model M to process the input information C and generate fingering information Z (Sa4). The controller 11 (the presentation processor 23) presents the fingering information Z to the user U (Sa5 and Sa6). Specifically, the controller 11 generates musical score information P for the musical scores B from the fingering information Z (Sa5) and displays the musical scores B on the display 14 (Sa6).

The controller 11 determines whether a predetermined stop condition is met (Sa7). The stop condition is, for example, a condition where the controller 11 receives an instruction to stop the playing analysis procedures Sa from the operation device 13 operated by the user U. Alternatively, the stop condition may be a condition where a predetermined time has elapsed from the latest onset of the string instrument 200. If the stop condition is not met (Sa7: NO), the controller 11 moves the processing to step Sa1. Thus, acquisition of the input information C (Sa2 and Sa3), generation of the fingering information Z (Sa4), and presentation of the fingering information Z (Sa5 and Sa6) are repeated for each onset of the string instrument 200. In contrast, if the stop condition is met (Sa7: YES), the playing analysis procedures Sa stop.

As will be clear from the foregoing description, in the first embodiment, the input information C, which includes the sound information X and the finger information Y, is processed by the generation model M to generate the fingering information Z. As a result, it is possible to generate fingering information Z for the following: music sound (audio signal Qx) generated by the string instrument 200 during playing by the user U, and an image (image signal Qy) representing playing by the user U of the string instrument 200. In other words, it is possible to provide the fingering information Z for playing of the string instrument 200 by the user U. In the first embodiment, in particular, the musical score information P is generated by using the fingering information Z. Display of the musical scores B enables the user U to effectively use the fingering information Z.

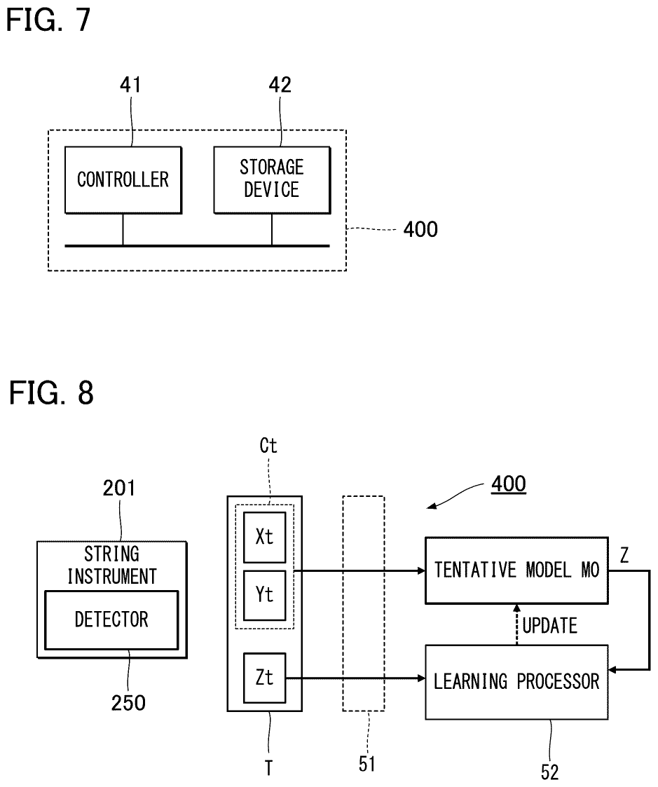

FIG. 7 is a block diagram showing an example of a configuration of a machine learning system 400 according to the first embodiment. The machine learning system 400 is a computer system, in which a generation model M for use by the information processing system 100 is established using machine learning. The machine learning system 400 includes a controller 41 and a storage device 42.

The controller 41 comprises one or more processors for controlling each element of the machine learning system 400. For example, the controller 41 may comprise one or more processors, such as a CPU, a GPU, a SPU, a DSP, a FPGA, or an ASIC.

The storage device 42 comprises one or more memories for storing a program executed by the controller 41 and a variety of data used by the controller 41. The storage device 42 may be a known recording medium, such as a magnetic recording medium or a semiconductor recording medium. The storage device 42 may comprise combinations of types of recording media. The storage device 42 may be a portable recording medium that is attached to or detached from the machine learning system 400, or a recording medium (e.g., a cloud storage) that is accessed by the controller 41 via a network.

FIG. 8 is a block diagram showing an example of a functional configuration of the machine learning system 400. The storage device 42 stores a plurality of training data T. Each of the plurality of training data T is teacher data that includes training input information Ct and training fingering information Zt.

The training input information Ct includes sound information Xt and finger information Yt. The sound information Xt is data on music sound of the string instrument 201 played by any of a large number of players (hereinafter, “reference player”). Specifically, by the sound information Xt, a pitch of a sound is identified which is generated by the string instrument 201 played by a reference player. The finger information Yt is data on a captured image of the left hand of the reference player and the fretboard of the string instrument 201. Thus, the finger information Yt represents an image of the left hand of the reference player and an image of the fretboard of the string instrument 201.

The fingering information Zt included in the training data T is data representative of fingering of a reference player playing the string instrument 201. In other words, the fingering information Zt included in the plurality of training data T indicates a ground truth, which is generated by the generation model M and used as the input information Ct of the training data T.

Specifically, the fingering information Zt identifies a finger number of the left hand of the reference player use to fret a string of the string instrument 201 and a position at which the string is fretted. The position at which the string is fretted is indicated by the fingering information Zt, and is detected by a detector 250 installed in the string instrument 201. The detector 250 is an optical or mechanical sensor that is mounted to, for example, the fretboard of the string instrument 201. A known technique, such as that disclosed in U.S. Pat. No. 9,646,591, may be adopted for detecting a position at which to fret a string indicated by the fingering information Zt. As will be clear from the foregoing description, training fingering information Zt is generated from a result provided by the detector 250 installed in the string instrument 201 by detecting playing of the reference player. As a result, time and effort can be reduced in preparation of training data T for use in the machine learning of the generation model M.

The controller 41 of the machine learning system 400 executes a program stored in the storage device 42 to implement functions for generating the generation model M (a training data acquirer 51 and a learning processor 52). The training data acquirer 51 acquires a plurality of training data T. The learning processor 52 establishes a generation model M by machine learning that uses the plurality of training data T.

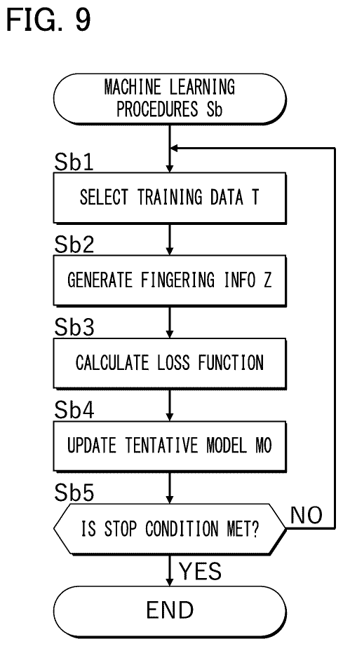

FIG. 9 is a flow chart showing procedures Sb by which a generation model M is established by the controller 41 using the machine learning (hereinafter, “machine learning procedures”). For example, the machine learning procedures Sb start upon receipt of an instruction from a human operator of the machine learning system 400.

Upon start of the machine learning procedures Sb, the controller 41 (the training data acquirer 51) selects one or more of the plurality of training data T (hereinafter, “selected training data T”) (Sb1). The controller 41 (the learning processor 52) repeatedly updates coefficients of an initial or tentative generation model M (hereinafter, “tentative model M0”) using the selected training data T (Sb2 to Sb4).

The controller 41 causes the tentative model M0 to process input information Ct of the selected training data T, to generate fingering information Z (Sb2). The controller 41 calculates a loss function representative of an error between the fingering information Z generated by the tentative model M0 and the fingering information Zt of the selected training data T (Sb3). The controller 41 updates the variables of the tentative model M0 to reduce the loss function (ideally minimize the loss function) (Sb4). For example, an error back propagation method is used to update the variables in accordance with the loss function.

The controller 41 determines whether a predetermined stop condition is met (Sb5). The stop condition is met when the loss function is below a predetermined threshold, or an amount of change in the loss function is below a predetermined threshold. If the stop condition is not met (Sb5: NO), the controller 41 selects straining data T that has not been selected yet as new selected training data T (Sb1). Until the stop condition is met (Sb5: YES), update of the variables of the tentative model M0 (Sb1 to Sb4) is repeated. If the stop condition is met (Sb5: YES), the controller 41 stops the machine learning procedures Sb. The tentative model M0 provided at a time when the stop condition is met is defined as a trained generation model M.

As will be clear from the foregoing description, the generation model M learns a potential relationship between input information Ct and fingering information Zt included in each of the plurality of training data T. Thus, the trained generation model M outputs statistically reasonable fingering information Z for unknown input information C in accordance with the relationship.

The controller 41 transmits the generation model M established by the machine learning procedures Sb to the information processing system 100. Specifically, variables defining the generation model M are transmitted to the information processing system 100. The controller 11 of the information processing system 100 receives the generation model M from the machine learning system 400 and stores the generation model M in the storage device 12.

### B: Second Embodiment

Description will now be given of a second embodiment. In the embodiments described below, like reference signs are used for elements that have functions or effects that are the same as those of elements described in the first embodiment, and detailed explanation of such elements is omitted as appropriate.

A configuration and operation of an information processing system 100 in the second embodiment are the same as those in the first embodiment. The second embodiment provides the same effects as the first embodiment. In the second embodiment, fingering instruction Zt, which is included in a piece of training data T and is used in the machine learning procedures Sb, differs from the first embodiment.

In the first embodiment, the training data T includes (i) input information Ct (sound information Xt and finger information Yt) for playing by each reference player and (ii) fingering information Zt for playing by each reference player. The training data T is used in the machine learning procedures Sb for the generation model M. The input information Ct and the fingering information Zt included in the training data T are used for playing by the same reference player.

In the second embodiment, the input information Ct of the training data T indicates information (sound information Xt and finger information Yt) for playing by a large number of reference players, as in the first embodiment. The fingering information Zt included in the training data T indicates fingering of playing by one specific player (hereinafter, “target player”). The target player may be a music artist playing the string instrument 200 with characteristic fingering, or a music instructor playing the string instrument 200 with model fingering. Thus, in the second embodiment, the input information Ct included in the training data T is used for playing by a player (i.e., the reference player). The fingering information Zt included in the training data T is used for playing by a different player (i.e., the target player).

A captured image of how a target player playing the string instrument is analyzed to prepare fingering information Zt for the target player included in the training data T. For example, the fingering information Zt is generated from an image of live music or from a music video in which the target player appears. As a result, fingering particular to the target player is applied to the fingering information Zt. For example, the following are applied to the fingering information Zt: strings tend to be fretted with high frequency within a particular area of the fretboard of the string instrument, and strings tend to be fretted with high frequency by a particular finger of the left hand.

As will be clear from the foregoing description, the generation model M according to the second embodiment is used for playing by the user U (the sound information Xt and the finger information Yt) and generates fingering information Z in which a tendency of fingering of the target player is applied. For example, under an assumption that the target player plays a piece of music similarly to the user U, the fingering information Z indicates fingering that would be adopted by the target player. Thus, when the user U checks the musical scores B shown based on the fingering information Z, the user U is made aware that the target player would play the piece of music with a fingering similar to that of the user U.

For example, according to the second embodiment, a target player such as s music artist or a music instructor can provide a good customer experience by providing his/her fingering information Z to a large number of users U. The users U can also have a customer experience by practicing a string instrument while referring to fingering information Z of a desired target player.

### C: Third Embodiment

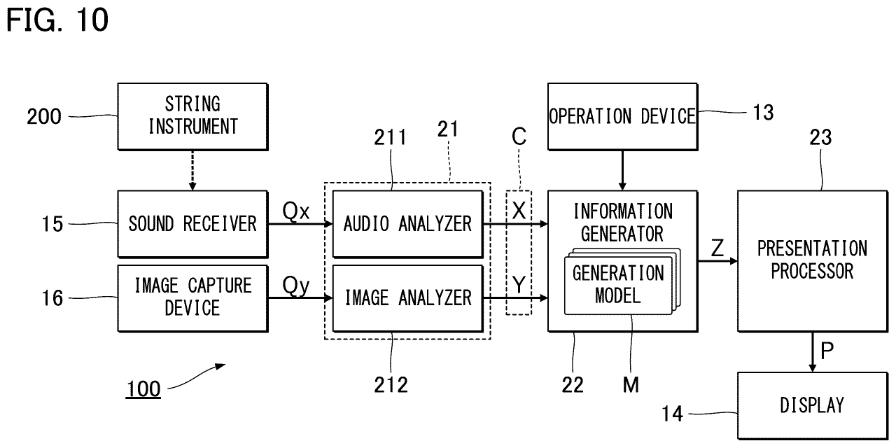

FIG. 10 is a block diagram showing an example of a functional configuration of an information processing system 100 according to a third embodiment. In the third embodiment, multiple generation models M are selectively used for different target players. Each generation model M is equivalent to the generation model M according to the second embodiment. One generation model M for one target player is a trained model that learns a relationship between training input information Ct and training fingering information Zt indicative of fingering of the target player.

Specifically, in the third embodiment, a plurality of training data T is prepared for each target player. The Machine learning procedures Sb use the plurality of training data T for one target player, and by the machine learning procedures Sb one generation model M is established for each target player. The generation model M for a corresponding target player is used for playing by the user U (sound information Xt and finger information Yt) and generates fingering information Z in which a fingering tendency of the target player is applied.

The user U selects any of the target players by operating the operation device 13. The information generator 22 receives the target player selected by the user U. The information generator 22 generates fingering information Z by causing a generation model M to process input information C (Sa4). Where, the generation model M is provided for the target player selected by the user U from among the generation models M. As a result, the fingering information Z generated by the generation model M indicates fingering that would be adopted by the selected target player under the assumption that the same piece of music is played by the selected target player and the user U.

The third embodiment provides the same effect as those obtained in the second embodiment. In the third embodiment, in particular, any of the generation models M for different target players is selectively used. As a result, it is possible to generate fingering information Z in which a fingering tendency particular to a target player is applied.

### D: Fourth Embodiment

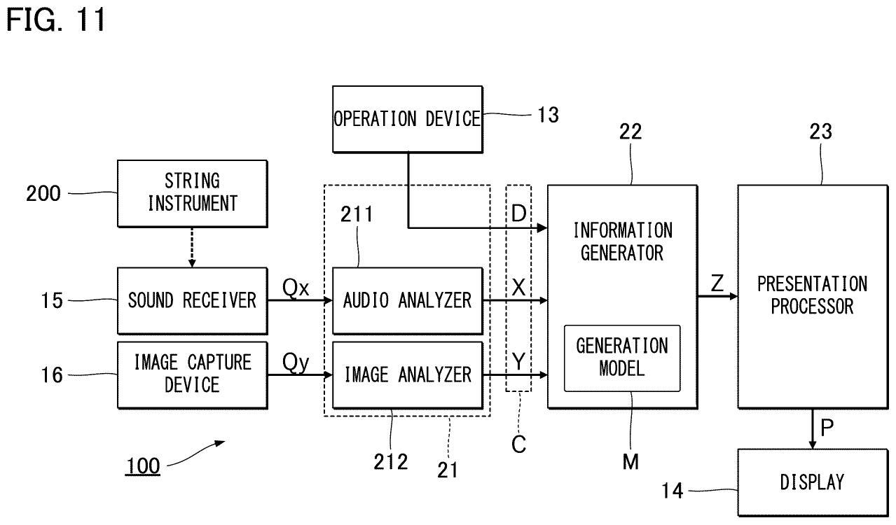

FIG. 11 is a block diagram showing an example of a functional configuration of an information processing system 100 according to a fourth embodiment. Input information C according to the fourth embodiment includes identification information D in addition to sound information X and finger information Y similar to the first embodiment. The identification information D is a code sequence for identifying any of target players.

As in the third embodiment, the user U selects any of the target players by operating the operation device 13. The information acquirer 21 generates identification information D for the target player selected by the user U. Thus, the information acquirer 21 generates input information C including sound information X, finger information Y, and the identification information D.

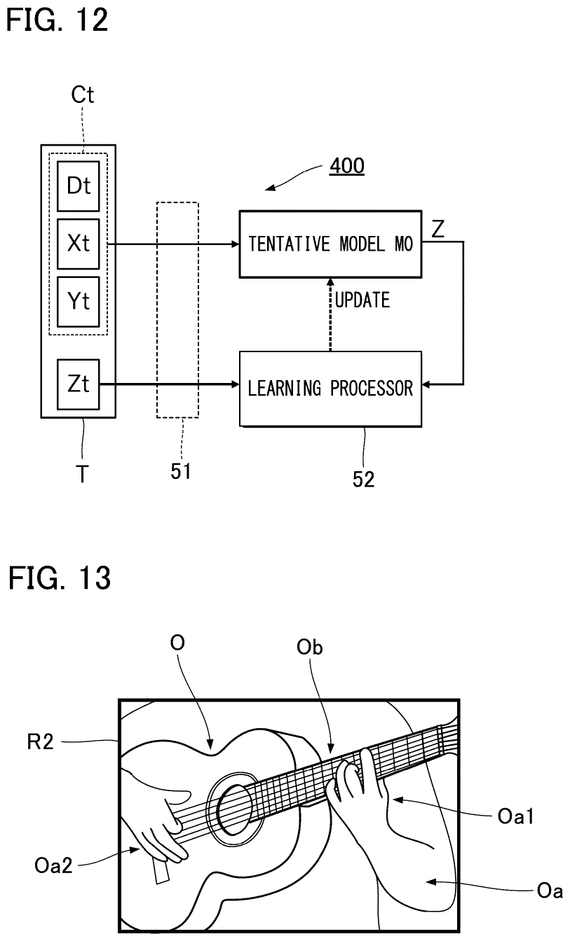

FIG. 12 is a block diagram showing an example of a functional configuration of a machine learning system 400 according to the fourth embodiment. In the fourth embodiment, similarly to the third embodiment, training data T is prepared for each target player. Training data T for a target player includes training identification information Dt in addition to sound information Xt and finger information Yt, similarly to the first embodiment. The identification information Dt is a code sequence for identifying any of the target players. The training data T for the target player includes fingering information Zt, which indicates fingering of the target player in playing the string instrument 200. Thus, a tendency in playing of the string instrument 200 by the target player is applied to the fingering information Zt for the target player.

In the third embodiment, the machine learning procedures Sb use a plurality of training data T for one target player, and by the machine learning procedures a generation model M is generated for each target player. In the fourth embodiment, the machine learning procedures Sb use training data T for one player, and by the machine learning procedures Sb a single generation model M is generated for different target players. In other words, the generation model M according to the fourth embodiment is a model that learns a relationship between the following (i) and (ii):
(i) training input information Ct for each of the target players, the training input information Ct including identification information D for a corresponding target player, and
(ii) training fingering information Zt indicative of fingering of the corresponding target player.

The generation model M is used for playing by the user U (sound information Xt and finger information Yt) and generates fingering information Z in which a fingering tendency of the target player selected by the user U is applied.

As described above, the fourth embodiment provides the same effects as those obtained in the second embodiment. In particular, in the fourth embodiment, the input information C includes the identification information D for a corresponding target player. As a result, as in the third embodiment, it is possible to generate fingering information Z in which a fingering tendency particular to a target player is applied.

### E: Fifth Embodiment

The presentation processor 23 according to the fifth embodiment displays on the display 14, a reference image R2 shown in FIG. 13 by using fingering information Z. A configuration and operation other than the presentation processor 23 are the same as those in the first through fourth embodiments. Thus, the fifth embodiment provides the same effects as those obtained in the first through fourth embodiments.

The reference image R2 includes virtual objects O in a virtual space. The virtual objects O are each a stereoscopic image representative of how a virtual player Oa playing a virtual string instrument Ob. The virtual player Oa includes a left hand Oa1 fretting the string instrument Ob and a right hand Oa2 plucking the string instrument Ob. A state of the virtual objects O (particularly, the left hand Oa1) change over time based on the fingering information Z sequentially generated by the information generator 22. As described above, the presentation processor 23 according to the fifth embodiment displays on the display 14, the reference image R2 representative of the virtual player Oa (Oa1 and Oa2) and the virtual string instrument Ob.

The fifth embodiment provides the same effects as those obtained in the first through fourth embodiments. In particular, in the fifth embodiment, the virtual player Oa with fingering indicated by the fingering information Z is shown on the display 14 together with the virtual string instrument Ob. As a result, the user U can visually check with ease the fingering indicated by the fingering information Z.

The display 14 may be mounted to an HMD (Head Mounted Display) that is worn on the head of the user U. The presentation processor 23 displays on the display 14, the virtual objects O (the player Oa and the string instrument Ob) captured by a virtual camera in the virtual space. The virtual objects O are displayed as the reference image R2. The presentation processor 23 dynamically controls a position and an orientation of the virtual camera in the virtual space based on a movement (e.g., a position and an orientation) of the head of the user U. As a result, the user U can view the virtual objects O from any position and direction in the virtual space by moving the head accordingly. The HMD with the display 14 may be of a transparent type, in which the physical background behind the virtual objects O is visible by the user U. Alternatively, the HMD may be of a non-transparent type, in which the virtual objects O are shown together with the background image of the virtual space. The transparent HMD shows the virtual objects O by use of, for example, Augmented Reality (AR) or Mixed Reality (MR). The non-transparent HMD shows the virtual objects O by use of, for example, Virtual Reality (VR).

The display 14 may be mounted to a terminal device communicable with the information processing system 100 via a network, such as the Internet. The presentation processor 23 transmits image data indicative of the reference image R2 to the terminal device to display the reference image R2 on the display 14 of the terminal device. The display 14 of the terminal device may be or may not be mounted to the head of the user U.

### F: Modifications

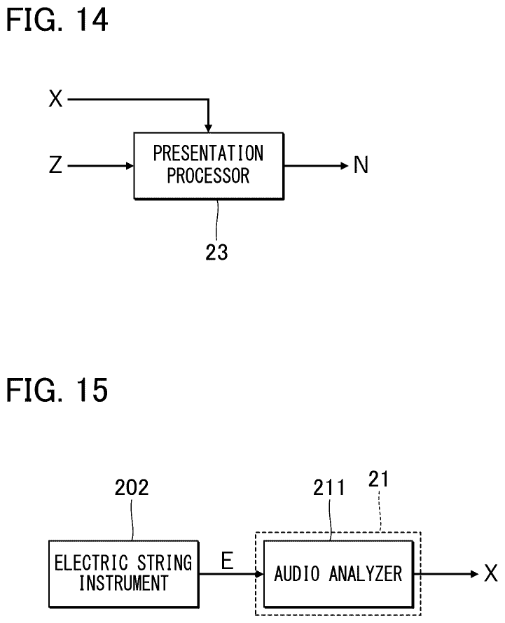

Specific modifications applicable to each of the aspects described above are set out below. Modes freely selected from the foregoing embodiments and the following modifications may be combined with one another as appropriate as long as such combination does not give rise to any conflict.
(1) In the foregoing embodiments, an exemplary aspect is given for displaying musical scores B indicated by fingering information Z on the display 14. However, application of the fingering information Z is not limited to such an example. For example, as shown in FIG. 14, the presentation processor 23 may generate content N based on the fingering information Z and the sound information X. The content N include the musical scores B, which are generated from a time series of the fingering information Z, and a time series of pitches, each of which is indicated by sound information X for a corresponding onset. When the content is played back by a playback device, sound with pitches indicated by the respective sound information X is played back in conjunction with display of the musical scores B. As a result, a person viewing the content can listen to a sound of the piece of music while viewing the musical scores B. The content is useful as teaching materials for practice or instruction of playing the string instrument 200.
(2) In the foregoing embodiments, an exemplary aspect is described in which a pitch is identified by sound information X. However, information identified by the sound information X is not limited to a pitch. For example, the sound information X may be a frequency response of an audio signal Qx. The frequency response of the audio signal Qx may be intensity spectrums (amplitude spectrums or power spectrums) or Mel-Frequency Cepstrum Coefficients (MFCC). The sound information X may be a time series of samples comprising the audio signal Qx. As will be clear from such examples, the sound information X is comprehensively represented as information about a sound of playing the string instrument 200 by the user U.
(3) In the foregoing embodiments, an exemplary aspect is given where an audio signal Qx is analyzed to generate a sound information X. However, the method for generating the sound information X is not limited to such embodiments. For example, as shown in FIG. 15, based on playing information E sequentially supplied from an electric string instrument 202, the audio analyzer 211 may generate sound information X. The electric string instrument 202 is a MIDI (Musical Instrument Digital Interface) instrument that outputs playing information E indicative of playing by user U. The playing information E is event data for identifying a pitch and intensity of sound generated by playing by the user U. The playing information E is output from the electric string instrument 202 each time the user U plucks a string. For example, the audio analyzer 211 generates a pitch included in the playing information E, and the generated pitch is indicated by sound information X. The audio analyzer 211 may detect an onset based on the playing information E. For example, the audio analyzer 211 detects a time point at which the playing information E for sounding is supplied from the electric string instrument 202, and the detected time point is an onset.
(4) In the foregoing embodiments, an audio signal Qx is analyzed and thereby an onset of the string instrument 200 is detected. However, the method for detecting an onset is not limited to such an example. For example, the image analyzer 212 may analyze an image signal Qy to detect a sound source of the string instrument 200. As described above, a player image Ga represented by the image signal Qy includes a right hand image Ga2 representative of the right hand of the user U used to pluck strings. The image analyzer 212 extracts a right hand image Ga2 from the playing image G and analyzes change in the right hand image Ga2 to detect plucking of a string. A time point at which the string is plucked by the user U is detected as an onset.
(5) Examples of a technique for playing the string instrument 200 (e.g., a guitar) include an arpeggio whereby notes are played sequentially, and a stroke whereby notes constituting a chord are played at substantially simultaneously. In analysis of playing of the string instrument 200 (especially, onsets), the arpeggio may be distinguished from the stroke. For example, when notes are played sequentially at intervals exceeding a predetermined threshold, an onset is detected for note (in the arpeggio). In contrast, when notes are played at intervals below the threshold, the same onset is detected for notes (stroke). Thus, the technique for playing the string instrument 200 may be applied to detection of onsets. Onsets may be represented discretely on a time axis. In an aspect in which onsets represented discretely, one onset is identified for notes played at intervals below the threshold.
(6) In the foregoing embodiments, an exemplary aspect is given of finger information Y including a left hand image Ga1 and a fretboard image Gb1. However, the finger information Y may include a right hand image Ga2 in addition to the left-hand image Ga1 and the fretboard image Gb1. According to this configuration, it is possible to generate the fingering information Z as fretting of strings by the right hand and plucking of strings by the left hand of the user U. Similarly, finger information Yt included in input information Ct of training data T may include a right hand image used to pluck strings by the right hand of a reference player.
(7) In the foregoing embodiments, an exemplary aspect is given of finger information Y including a player image Ga (a left hand image Ga1 and a right hand image Ga2) and an instrument image Gb (a fretboard image Gb1). However, a format of the finger information Y is freely selectable. The image analyzer 212 may generate as the finger information Y, coordinates of each characteristic point extracted from a playing image G. For example, the finger information Y may indicate coordinates of each node (e.g., finger joints or tips) included in the left hand image Ga1 of the user U. Alternatively, the finger information Y may indicate coordinates of each point at which a string and a fret intersects with each other in the fretboard image Gb1 of the string instrument 200. In an aspect of a right hand image Ga2 reflected in the finger information Y, the finger information Y may indicate coordinates of each node (e.g., finger joints or tips) included in a right hand image Ga2 of the user U. As will be clear from such examples, the finger information Y is comprehensively represented as information about the player image Ga and the instrument image Gb.
(8) In the third embodiment, any of the generation models M can be selected in accordance with an instruction from the user U. However, the method for selecting a generation model M is not limited to such an example. The method of selecting any of the target players is freely selectable. For example, the information generator 22 may select any of the generation models M in accordance with an instruction from an external device or as a result of a predetermined numeric calculation. Similarly in the fourth embodiment, the method of selecting any of the target players is freely selectable. For example, the information acquirer 21 may generate identification information D for any of the target players in accordance with instructions from an external device or as a result of a predetermined numeric calculation.
(9) In the foregoing embodiments, an example of a deep neural network is given as a generation model M for generating fingering information Z. However, the generation model M is not limited to such an example. For example, a statistical model, such as an HMM (Hidden Markov Model) or a SVM (Support Vector Machine) may be used as the generation model M.
(10) In each of the foregoing embodiments, the generation model M is used to learn a relationship between input information C and fingering information Z. However, the configuration and method for generating the fingering information Z from the input information C are not limited to such an example. For example, a reference table in which fingering information Z is associated with input information C may be used by the information generator 22 to generate the fingering information Z. The reference table is a data table including correspondences between the input information C and the fingering information Z. The reference table is stored in, for example, the storage device 12. The information generator 22 searches the reference table for fingering information Z associated with the input information C that is acquired by the information acquirer 21.
(11) In the foregoing embodiments, a generation model M is established by the machine learning system 400. However, functions for establishing the generation model M (the training data acquirer 51 and the learning processor 52) may be mounted to the information processing system 100.
(12) In the foregoing embodiments, an example is given of fingering information Z indicative of a finger number and a position at which a string is fretted. However, the fingering information Z is not limited to such an example. For example, the fingering information Z may indicate a variety of methods for playing string instruments used for musical expressions, in addition to commonly used fingering defined by a finger number and a position at which a string is fretted. Examples of methods for playing string instruments indicated by the fingering information Z include vibrato, slide, glissando, pull off, hammering, and choking. Known expression estimation models are used to estimate a method used in playing a string instrument.
(13) A type of the string instrument 200 is freely selectable. The string instrument 200 is comprehensively represented as an instrument provided with strings that are caused to vibrate to generate sound. The string instrument 200 includes a plucked string instrument and a bowed string instrument. The plucked instrument corresponds to the string instrument 200 in which strings vibrate to generate sound. Examples of the plucked instrument include an acoustic guitar, an electric guitar, an acoustic bass, an electric bass, an ukulele, a banjo, a mandolin, a harp, and a shamisen. The bowed string instrument is a string instrument that generates sound when the strings are bowed. Examples of the bowed string instrument include a violin, a viola, a cello, and a contrabass. This disclosure applies to any types of such string instruments for analysis of playing.
(14) For example, the information processing system 100 may be implemented by a server apparatus that communicates with a terminal device, such as a smartphone or a tablet. For example, the information acquirer 21 of the information processing system 100 receives an audio signal Qx (or playing information E) and an image signal Qy from the terminal device. The information acquirer 21 generates sound information X based on the audio signal Qx and generates finger information Y based on the image signal Qy. The information generator 22 generates fingering information Z from input information C including the sound information X and the finger information Y. The presentation processor 23 generates musical score information P from the fingering information Z and transmits the musical score information P to the terminal device. The terminal device displays on its display, musical scores B represented by the musical score information P.

In a configuration in which the audio analyzer 211 and the image analyzer 212 are mounted to the terminal device, the information acquirer 21 receives the sound information X and the finger information Y from the terminal device. As will be clear from the foregoing description, the information acquirer 21 corresponds to an element for generating the sound information X and the finger information Y. Alternatively, the information acquirer 21 corresponds to an element for receiving the sound information X and the finger information Y from another device, such as the terminal device. In other words, the “acquisition” of the sound information X and finger information Y includes both generation and reception.

In a configuration in which the presentation processor 23 is mounted to the terminal device, the fingering information Z generated by the information generator 22 is transmitted from the information processing system 100 to the terminal device. The presentation processor 23 displays on the display, the musical score information P generated from the fingering information Z. As will be clear from the foregoing description, the presentation processor 23 may be omitted from the information processing system 100.
(15) The functions of the information processing system 100 according to the foregoing embodiments are implemented by cooperation between one or more processors comprising the controller 11 and a program stored in the storage device 12. The program may be provided for use in a computer by being stored on a computer-readable recording medium. Preferred examples of a recording medium include, a non-transitory recording medium, an optical recording medium (optical disk), such as a CD-ROM. Examples of the recording medium further include any type of known recording medium, such as a semiconductor recording medium or a magnetic recording medium. Examples of the non-transitory recording medium include any recording medium other than a transitory propagating signal. A volatile recording medium is not excluded. In a configuration in which the program is distributed by a distribution apparatus via a network, the recording medium used to store the program in the distribution apparatus corresponds to the non-transient recording medium.

### G: Appendices

The following configurations are derivable from the foregoing embodiments.

A method according to an aspect (Aspect 1) of this disclosure is a computer-implemented method for processing information that is executable by a computer system. The method includes: acquiring, by the computer system, input information including: finger information relating to fingers of a user playing a string instrument and an image of a fretboard of the string instrument; and sound information of sound of the string instrument played by the user; and generating, by the computer system, fingering information indicative of fingering by processing the acquired input information using at least one generation model that learns a relationship between training input information and training fingering information.

In this aspect, the fingering information is generated by processing the input information including the finger information and the sound information by using the trained generation model. In other words, the fingering information can be provided which relates to fingering when the user plays the string instrument.

The “finger information” is any data format of an image of the fingers of the user and an image of the fretboard of the string instrument. For example, the finger information may be image information that represents an image of the finger of the user and an image of the fretboard of the string instrument. Alternatively, the finger information may be analysis information generated by the image information. For example, the analysis information may indicate coordinates of each node (e.g., the finger joints or tips) of any finger of the user, a line segment between the nodes, the fretboard, or a fret on the fretboard.

The “sound information” is any data format for sound generated when the user plays the string instrument. For example, the sound information indicates feature amounts of tone playing by the user. For example, the feature amounts are identified by analyzing an audio signal indicative of vibrations of strings of the string instrument. For example, for a string instrument that outputs playing information in MIDI format, sound information for identifying a pitch of the playing information is generated. A time series of samples of an audio signal may be used as the sound information.

The “fingering information” is any format data indicative of fingering in playing of a string instrument. For example, the fingering information may comprise a finger number indicative of a finger used to fret a string and a position of the fret (a combination of a fret and a string).

The generation model is a trained model that learns relationships between input information and fingering information by using machine learning. A plurality of training data is used for the machine learning of the generation model. The plurality of training data includes training input information and training fingering information (ground truth). Examples of the generation model include a variety of statistical models, such as a deep neural network (DNN), HMM, and SVM.

An example (Aspect 2) according to Aspect 1, further includes detecting one or more onsets of the string instrument, in which acquisition of the input information and generation of the fingering information are executed for each of the one or more onsets.

In this aspect, the acquisition of the input information and the generation of the fingering information are executed for each onset of the string instrument. As a result, unnecessary generation of fingering information is avoided when a string is fretted by the user U without a sounding operation. The “sounding operation” is an action that causes the string instrument to generate a sound upon fretting a string. Specifically, the sounding operation is an action of plucking a string of a plucked string instrument, or an action of bowing a string of a bowed string instrument.

An example (Aspect 3) according to Aspect 1 or 2, further includes generating, by the computer system, based on the fingering information, musical score information indicative of a musical score for playing the string instrument by the user.

In this aspect, musical score information is generated by using the fingering information. The finger information can be effectively used by the user if a musical scored is output (e.g., displayed or printed). The “musical score” represented by the “musical score information” is, for example, a tablature score showing fretted string positions of strings of the string instrument. However, the music information may indicate a staff score specifying note pitches to be played.

An example (Aspect 4) according to any of Aspects 1 to 3, further includes showing on a display, by the computer system, a reference image representative of: a virtual player with fingering indicated by the fingering information; and a virtual string instrument played with the fingering.

In this aspect, a virtual finger with the fingering indicated by the fingering information and the virtual string instrument are displayed on the display. As a result, the user can visually check with ease the fingering indicated by the fingering information.

In an example (Aspect 5) according to any of Aspect 4, the display is worn on the head of the user. The showing the reference image includes showing on the display, by the computer system, a captured image representative of the virtual player and the virtual string instrument in a virtual space. The captured image is taken by a virtual camera in a position and an orientation in the virtual space controlled based on a movement of the head of the user and is shown as the reference image.

According to this aspect, the user can view the virtual player and the virtual string instrument from a desired position and direction.

In an example (Aspect 6) according to Aspect 4 or 5, the display is included in a terminal apparatus. The displaying the reference image includes: transmitting, by the computer system, image data indicative of the reference image to the terminal apparatus via a network: and displaying, by the terminal apparatus, the reference image transmitted from the computer system, on the display of the terminal apparatus.

According to this aspect, even if the terminal apparatus does not have a function for generating finger information, the user of the terminal apparatus can view the virtual player and the virtual string instrument corresponding to the finger information.

An example (Aspect 7) according to any one of Aspects 1 to 6, further includes generating, by the computer system, content based on the sound information and the fingering information.

According to this aspect, it is possible to generate content for checking a correspondence between the sound information and the fingering information. The content is useful for practice or guidance in playing the string instrument.

In an example (Aspect 8) according to any one of Aspects 1 to 7, the input information includes identification information for any of a plurality of players. The at least one generation model learns a relationship between: training input information for each of the plurality of players, training input information including identification information for a corresponding player; and the training fingering information indicative of fingering of the corresponding player.

In this aspect, the input information includes the identification information for the player. As a result, it is possible to generate fingering information in which a fingering tendency particular to each player is applied.

In an example (Aspect 9) according to any one of Aspects 1 to 7, the at least one generation model includes a plurality of generation models for different players. The generating fingering information includes generating, by the computer system, the fingering information by processing the acquired input information using any of the plurality of generation models. Each of the plurality of generation models is a model that learns a relationship between: the training input information; and the training fingering information indicative of fingering of a corresponding player from among the different players.

In this aspect, any of the models for the respective different players is selectively used. As a result, it is possible to generate fingering information in which a fingering tendency peculiar to each player is applied.

In an example (Aspect 10) according to any one of Aspects 1 to 9, the string instrument includes a detector that detects playing by a player. The training fingering information is generated by using a result provided by the detector.

In this aspect, the training fingering information is generated by using a result provided by the detector installed in the string instrument. As a result, time and effort are reduced for preparation of training data for use in the machine learning of the generation model.

An information processing system according to an aspect (Aspect 11) of this disclosure includes: at least one memory storing a program; at least one processor configured to execute the program to: acquire input information including: finger information relating to fingers of a user playing a string instrument and an image of a fretboard of the string instrument; and sound information of sound of the string instrument played by the user; and generate fingering information indicative of fingering by processing the acquired input information using at least one generation model that learns a relationship between training input information and training fingering information.

A computer-readable non-transitory storage medium to an aspect of this disclosure (Aspect 12) is a recording medium for storing a program executable by a computer system to execute a method of: acquiring input information including: finger information relating to a finger of a user playing a string instrument and an image of a fretboard of the string instrument; and sound information of sound of the string instrument played by the user; and generating fingering information indicative of fingering by processing the acquired input information using at least one generation model that learns a relationship between training input information and training fingering information.

### DESCRIPTION OF REFERENCE SIGNS

100 . . . Information processing system, 200, 201 . . . string instrument, 202 . . . electric string instrument, 250 . . . detector, 11, 41 . . . controller, 12, 42 . . . storage device, 13 . . . operation device, 14 . . . display, 15 . . . sound receiver, 16 . . . image capture device, 21 . . . information acquirer, 211 . . . audio analyzer, 212 . . . image analyzer, 22 . . . information generator, 23 . . . presentation processor, 400 . . . machine learning system, 51 . . . training data acquirer, 52 . . . learning processor.

What is claimed is:

1. A computer-implemented method for processing information that is executable by a computer system, the method comprising:
acquiring, by the computer system, input information including:
finger information relating to fingers of a user playing a string instrument and an image of a fretboard of the string instrument; and
sound information of sound of the string instrument played by the user; and
generating, by the computer system, fingering information indicative of fingering by processing the acquired input information using at least one generation model that learns a relationship between training input information and training fingering information.

2. The method for processing information according to claim 1, further comprising: detecting one or more onsets of the string instrument,
wherein acquisition of the input information and generation of the fingering information are executed for each of the one or more onsets.

3. The method for processing information according to claim 1, further comprising: generating, by the computer system, based on the fingering information, musical score information indicative of a musical score for playing the string instrument by the user.

4. The method for processing information according to claim 1, further comprising: showing on a display, by the computer system, a reference image representative of:
a virtual player with fingering indicated by the fingering information; and
a virtual string instrument played with the fingering.

5. The method for processing information according to claim 4, wherein:
the display is worn on the head of the user,
the showing the reference image includes showing on the display, by the computer system, a captured image representative of the virtual player and the virtual string instrument in a virtual space, and
the captured image is taken by a virtual camera in a position and an orientation in the virtual space controlled based on a movement of the head of the user and is shown as the reference image.

6. The method for processing information according to claim 4,
wherein the display is included in a terminal apparatus, and
wherein the displaying the reference image includes:
transmitting, by the computer system, image data indicative of the reference image to the terminal apparatus via a network: and
displaying, by the terminal apparatus, the reference image transmitted from the computer system, on the display of the terminal apparatus.

7. The method for processing information according to claim 1, further comprising: generating, by the computer system, content based on the sound information and the fingering information.

8. The method for processing information according to claim 1, wherein:
the input information includes identification information for any of a plurality of players, and
the at least one generation model learns a relationship between:
training input information for each of the plurality of players, the training input information including identification information for a corresponding player; and
training fingering information indicative of fingering of the corresponding player.

9. The method for processing information according to claim 1, wherein:
the at least one generation model includes a plurality of generation models for different players,
the generating fingering information includes generating, by the computer system, the fingering information by processing the acquired input information using any of the plurality of generation models, and
each of the plurality of generation models is a model that learns a relationship between:
the training input information; and
the training fingering information indicative of fingering of a corresponding player from among the different players.

10. The method for processing information according to claim 1, wherein:
the string instrument includes a detector that detects playing by a player, and
the training fingering information is generated by using a result provided by the detector.

11. An information processing system comprising:
at least one memory storing a program;
at least one processor configured to execute the program to:
acquire input information including:
finger information relating to fingers of a user playing a string instrument and an image of a fretboard of the string instrument; and
sound information of sound of the string instrument played by the user; and
generate fingering information indicative of fingering by processing the acquired input information using at least one generation model that learns a relationship between training input information and training fingering information.

12. A computer-readable non-transitory storage medium for storing a program executable by a computer system to execute a method of:
acquiring input information including:
finger information relating to a finger of a user playing a string instrument and an image of a fretboard of the string instrument; and
sound information of sound of the string instrument played by the user; and
generating fingering information indicative of fingering by processing the acquired input information using at least one generation model that learns a relationship between training input information and training fingering information.
